(19) United States
(12) Patent Application Publication
(10) Pub. No.: US 2011/0232932 A1
(43) Pub. Date: Sep. 29, 2011

(54) Rechargeable Battery Apparatus for a Handheld Power Tool

(75) Inventors: Florian Bantle, Gruibingen (DE); Juergen Stoeger, Neckartailfingen (DE)

(73) Assignee: Robert Bosch GmbH, Stuttgart (DE)

(21) Appl. No.: 13/071,143

(22) Filed: Mar. 24, 2011

(30) Foreign Application Priority Data
Mar. 25, 2010 (DE) 10 2010 003 283.2

(51) Int. Cl. B25F 5/00; H01M 10/48; H01M 2/10; F21L 4/08

(52) U.S. Cl. 173/217; 429/90; 429/100; 362/183

(57) ABSTRACT

A rechargeable battery apparatus for a handheld power tool has at least one load interface which is configured to make contact with a load in a detachable manner. The load interface has at least one identification means for electronically identifying the load.

This application claims priority under 35 U.S.C. §119 to German patent application no. 10 2010 003 283.2, filed Mar. 25, 2010 in Germany, the disclosure of which is incorporated herein by reference in its entirety.

The present disclosure relates to a rechargeable battery apparatus for a handheld power tool.

### BACKGROUND

A rechargeable battery apparatus for a handheld power tool having at least one load interface which is intended to make contact with a load in a detachable manner has already been proposed.

### SUMMARY

The disclosure relates to a rechargeable battery apparatus for a handheld power tool having at least one load interface which is intended to make contact with a load in a detachable manner.

The disclosure proposes that the load interface has at least one identification means for electronically identifying the load. A “load interface” is to be understood to mean, in particular, an interface which is intended to supply at least an electrical power, in particular of more than 0.1 watt, advantageously of more than 1 watt, particularly advantageously of more than 3 watts, to a load. The term “load” is to be understood to mean, in particular, a heating pad, a boot warmer, a portable media player, in particular a pocket radio, a charger, in particular for cell phones, another load which would appear to be expedient to a person skilled in the art and/or, particularly advantageously, a load with a lamp unit for illuminating a working area. In this context, a “load” is to be understood to mean, in particular, a load which is not a handheld power tool. The load interface preferably provides a stabilized low voltage which is matched to the load. “Intended” is to be understood to mean, in particular, specially equipped, designed and/or programmed. The phrase “makes contact in a detachable manner” is to be understood to mean, in particular, that the load interface establishes a mechanical and electrical connection which can be broken by an operator. The connection of the load interface can advantageously be broken without tools. An “identification means” or “identification mechanism” is to be understood to mean, in particular, a device which outputs at least one characteristic variable in at least one operating state, which characteristic variable contains at least one item of information about a load and/or a load type. The identification means is preferably formed to be functionally separate from the load interface, that is to say, in particular, that no identification information is transmitted via the load interface. An “electronic identification process” is to be understood to mean, in particular, an identification process in which at least the characteristic variable of the identification means is electronically transmitted. A rechargeable battery for a handheld power tool can be used in a particularly versatile and reliable manner by virtue of the refinement of the rechargeable battery apparatus for a handheld power tool according to the disclosure. In particular, the rechargeable battery for a handheld power tool can be connected to a very wide variety of load types.

A further refinement proposes that the load interface has at least one electronics system which is intended to automatically influence a value of an output characteristic variable as a function of an identification process. An “electronics system” is to be understood to mean, in particular, an apparatus which influences an electric current in a gas, in a conductor, in a vacuum and/or advantageously in a semiconductor. The electronics system preferably influences the electric current as a function of the characteristic variable of the identification means. The electronics system preferably has at least one transistor, particularly advantageously at least one microcontroller. The phrase “as a function of an identification process” is to be understood to mean, in particular, that the electronics system influences the value of the output characteristic variable as a function of the characteristic variable of the identification means. In this context, “automatically” is to be understood to mean, in particular, that the electronics system, in at least one operating state, determines the value of the output characteristic variable from the characteristic variable of the identification means, independently of any influencing by the operator. The value of the output characteristic variable preferably cannot be set by the operator, that is to say the operator cannot select a value for the output characteristic variable, but advantageously can only enable and/or disable the output characteristic variable. An “output characteristic variable” is to be understood to mean, in particular, a characteristic variable which can be tapped off by a load. The output characteristic variable is preferably in the form of an, in particular electrical, power. The output characteristic variable particularly preferably comprises an electric current and/or advantageously an electric voltage. As an alternative or in addition, the output characteristic variable could be wireless, for example in the form of a magnetic field. The load interface preferably outputs the output characteristic variable. “Influence” is to be understood to mean, in particular, that the electronics system changes the value of the output characteristic variable in at least one operating state. Various loads and/or load types can be reliably supplied with a required value of the output characteristic variable, for example a required voltage, by the electronics system. Damage to the load due to an incorrectly selected value of the output characteristic variable by the operator is precluded in this case.

The disclosure also proposes that the identification means for identification purposes has at least one magnetic field sensor, as a result of which a particularly reliable identification process is possible in a structurally simple manner. A “magnetic field sensor” is to be understood to mean, in particular, an apparatus which provides a characteristic variable which is dependent on a magnetic field. Other refinements of the identification means, for example with conductive contacts, which appear to be expedient to a person skilled in the art are possible.

The disclosure further proposes that the load interface is intended to establish a connection which can be mechanically loaded and is electrically conductive, as a result of which particularly flexible and versatile use, in particular as a mounting means and/or pedestal, can be achieved. A “connection which can be mechanically loaded” is to be understood to mean, in particular, a connection which can be loaded in at least one direction with a torque of at least 0.1 Nm, advantageously 1 Nm, without being destroyed. In this case, the connection which can be mechanically loaded is intended to absorb other forces in addition to forces which are required to establish the electrically conductive connection. A “connection which is electrically conductive” is to be understood to mean, in particular, a connection with a contact resistance of less than 10 ohms, advantageously of less than 1 ohm.

The disclosure additionally proposes that the rechargeable battery apparatus for a handheld power tool has at least one rechargeable battery interface which is intended to make contact with at least one rechargeable battery for a handheld power tool in a detachable manner, as a result of which different rechargeable batteries for a handheld power tool which can be put to other uses can be used with the rechargeable battery apparatus for a handheld power tool. As an alternative, the rechargeable battery apparatus for a handheld power tool could be at least partially integrally formed with a rechargeable battery for a handheld power tool. A “rechargeable battery for a handheld power tool” is to be understood to mean, in particular, a rechargeable battery which is intended to supply electrical energy to handheld power tools, for example drills, hammer drills, saws, planes, screwdrivers, mills, grinders, angle grinders, gardening equipment and/or multifunctional tools. The rechargeable battery for handheld power tools preferably has at least a capacity of 2 Wh, particularly preferably of at least 5 Wh. The rechargeable battery for handheld power tools preferably has at least one lithium rechargeable battery cell. As an alternative or in addition, the rechargeable battery apparatus for a handheld power tool could also be operated with a battery. The rechargeable battery interface is preferably intended to be connected to rechargeable batteries for a handheld power tool of different designs.

The disclosure also proposes that the rechargeable battery apparatus for a handheld power tool has at least one display unit which displays at least one rechargeable battery characteristic variable in at least one operating state, as a result of which the operator can be advantageously informed about the at least one rechargeable battery characteristic variable of the rechargeable battery for a handheld power tool. A “display unit” is to be understood to mean, in particular, a unit which displays at least one item of information which can be read off by the operator. A “rechargeable battery characteristic variable” is to be understood to mean, in particular, an item of information about a state of the rechargeable battery for a handheld power tool. Conclusions can be drawn about a charge state and/or an energy output of the rechargeable battery for a handheld power tool.

The disclosure is based on a load having a coding means and a supply interface which is intended to be connected to a load interface of the rechargeable battery apparatus for a handheld power tool according to the disclosure. A “coding means” is to be understood to mean, in particular, a means which contains and advantageously provides at least one item of information about the load and/or the load type. The coding means preferably has a plurality of magnets. As an alternative or in addition, the coding means could have precisely one magnet. This one magnet advantageously has different strengths depending on the load type. The coding means could also have a plurality of magnets with different strengths. A “supply interface” is to be understood to mean, in particular, an interface which absorbs an operating energy of the load, in particular of a rechargeable battery for a handheld power tool, in at least one operating state.

An advantageous development of the disclosure proposes that the load has a lamp unit and a connecting apparatus which, in at least one operating state, arranges the lamp unit and the supply interface such that they can move relative to one another, as a result of which a particularly flexible and versatile illumination apparatus can be provided. A “lamp unit” is to be understood to mean, in particular, an apparatus having a lighting means and a lighting means housing. The lamp unit preferably has at least one means which influences the light emitted by the lighting means, for example a reflector and/or a lens. The lamp unit advantageously emits a luminous flux of at least 5 lumens, particularly advantageously at least 50 lumens. A “connecting apparatus” is to be understood to mean, in particular, an apparatus by means of which at least one force can be transmitted from the lamp unit to the supply interface. The connecting apparatus can preferably be deformed by the operator. The connecting apparatus advantageously sets a force against a deformation. The connecting apparatus preferably has a flexible tube or another means which appears to be expedient to a person skilled in the art. The connecting apparatus advantageously separates the lamp unit from the supply interface at least by 2 cm, particularly advantageously by at least 10 cm. The phrase “arranged such that they can move relative to one another” is to be understood to mean, in particular, that the connecting apparatus is intended to allow a change in position and/or orientation of the lamp unit relative to the supply interface.

The disclosure further proposes that the lamp unit has an input interface which is intended to make contact with the connecting apparatus in a detachable manner, as a result of which a particularly flexible illumination system which can be used in different ways can be produced. An “input interface” is to be understood to mean, in particular, an apparatus which is intended to mechanically and advantageously electrically connect the lamp unit and the connecting apparatus. The lamp unit can preferably be used separately from a connecting apparatus. The lamp unit could, for example, be used as part of a headlamp, a universal luminaire, a work lamp and/or a bicycle lamp.

The disclosure is also based on a rechargeable battery lamp for a handheld power tool, having a lamp unit, a connecting apparatus and a rechargeable battery interface which is fixedly connected to the connecting apparatus in at least one operating state.

The disclosure proposes that the lamp unit has an input interface which is intended to make contact with the connecting apparatus in a detachable manner. An illumination apparatus which can be used in a particularly convenient manner can be produced by virtue of the refinement of the rechargeable battery lamp for a handheld power tool according to the disclosure.

### BRIEF DESCRIPTION OF THE DRAWING

Further advantages can be gathered from the following description of the drawings. The drawing shows three exemplary embodiments of the disclosure. The drawing, the description and the claims contain numerous features in combination. A person skilled in the art will expediently also take the features into consideration individually and combine them to form expedient further combinations.

In the drawing:

FIG. 1 shows a perspective illustration of a rechargeable battery apparatus for a handheld power tool according to the disclosure, a load according to the disclosure, a rechargeable battery lamp for a handheld power tool according to the disclosure and a rechargeable battery for a handheld power tool,

FIG. 2 shows a schematic side view of the rechargeable battery apparatus for a handheld power tool from FIG. 1,

FIG. 3 shows a perspective illustration of a load interface of the rechargeable battery apparatus for a handheld power tool from FIG. 1 and a supply interface of the load from FIG. 1,

FIG. 4 shows a perspective illustration of the supply interface of the load from FIG. 1,

FIG. 5 shows a perspective illustration of a part of the input interface of the rechargeable battery lamp for a handheld power tool from FIG. 1,

FIG. 6 shows a further exemplary embodiment of the load from FIG. 1, with the load being in the form of a headlamp,

FIG. 7 shows a connecting apparatus of the load from FIG. 6, and

FIG. 8 shows a mounting apparatus of a further exemplary embodiment of the load from FIG. 1.

### DETAILED DESCRIPTION

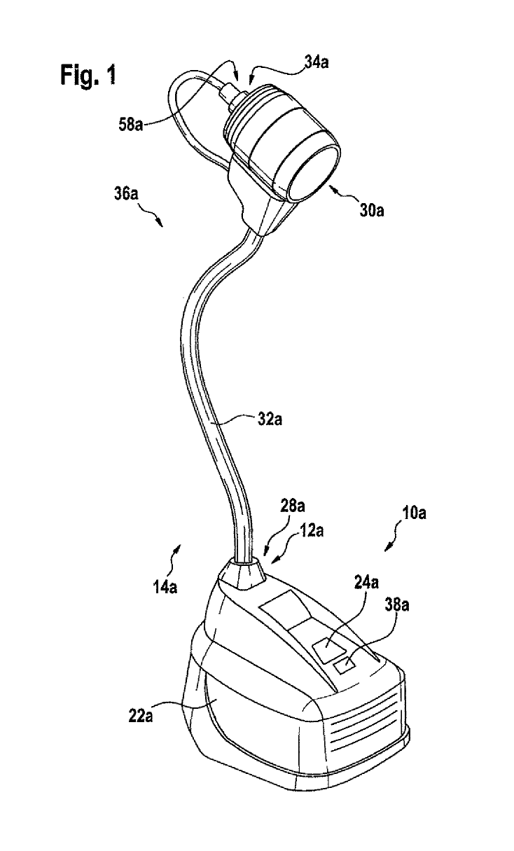

FIG. 1 shows a rechargeable battery apparatus 10a for a handheld power tool according to the disclosure, a load 14a according to the disclosure, a rechargeable battery lamp 36a for a handheld power tool according to the disclosure and a rechargeable battery 22a for a handheld power tool.

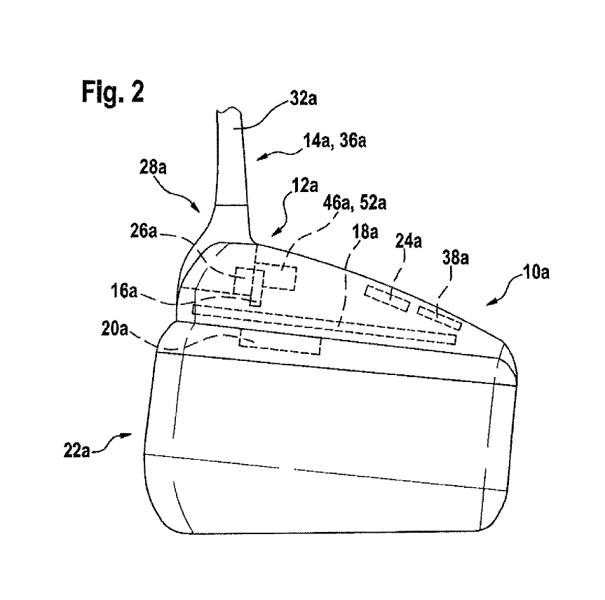

As shown in FIG. 2, the rechargeable battery apparatus 10a for a handheld power tool comprises a load interface 12a and a rechargeable battery interface 20a. The load interface 12a makes contact with the load 14a in a detachable manner in a ready-to-operate state.

The load interface 12a has an identification means 16a for electronically identifying the load 14a. To this end, the identification means 16a comprises a plurality of magnetic field sensors (not illustrated in any detail). Therefore, the identification means 16a detects a plurality of characteristic variables of the load 14a when the load 14a is connected to the rechargeable battery apparatus 10a for a handheld power tool. The characteristic variables are in the form of magnetic fields of magnets. The characteristic variables together describe which load type the load is associated with. The identification means 16a evaluates each characteristic variable in a binary fashion.

The load interface 12a has an electronics system 18a. The electronics system 18a has a microcontroller (not illustrated in any detail). During operation, the microcontroller evaluates the characteristic variables of the load 14a and, from this evaluation, determines a load type of the load 14a. Furthermore, the electronics system 18a has a power electronics system (not illustrated in any detail). The power electronics system converts, in a manner controlled and/or regulated by the microcontroller, an input characteristic variable arriving from the rechargeable battery 22a for a handheld power tool into an output characteristic variable which is matched to the load 14a. The input characteristic variable is in the form of a power and comprises a voltage which is predefined by the rechargeable battery 22a for a handheld power tool. In this exemplary embodiment, the power electronics system converts a value for the voltage of the rechargeable battery 22a for a handheld power tool into an electric voltage which is matched to the load 14a. Therefore, the electronics system 18a automatically influences a value of an output characteristic variable during operation as a function of an identification process. At least three different values of the output characteristic variable can preferably be set by the electronics system 18a.

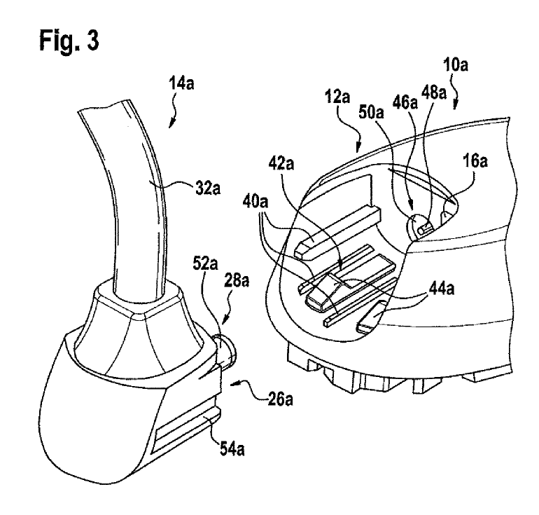

As shown in FIG. 3, the load interface 12 has a linear guide 40a and a latching apparatus 42a. The latching apparatus 42a comprises two latching hooks 44a. The latching apparatus 42a locks automatically when the rechargeable battery apparatus 10a for a handheld power tool is connected to the load 14a. The latching apparatus 42a can be detached by an operator (not illustrated in any detail) without tools. In addition, the load interface 12a has an electrically conductive contact 46a. The contact 46a consists of an internal conductor 48a and an external conductor 50a which is isolated from the internal conductor 48a. When the load interface 12a is connected to the load 14a, the contact 46a makes contact with a mating contact 52a of a supply interface 28a of the load 14a. Therefore the load interface 12a establishes a connection, which can be mechanically loaded and is electrically conductive, with the load in a ready-to-operate state.

The rechargeable battery apparatus 10a for a handheld power tool comprises the rechargeable battery interface 20a. The rechargeable battery interface 20a makes contact with the rechargeable battery 22a of a handheld power tool in a manner such that it can be detached by the operator without tools in a ready-to-operate state. To this end, the rechargeable battery interface 20a is in the form of an interface which appears to be expedient to a person skilled in the art, as can be found, for example, on a handheld power tool (not illustrated in any detail) which is matched to rechargeable battery 22a for the handheld power tool.

As shown in FIG. 1, the rechargeable battery apparatus 10a for a handheld power tool has a display unit 24a. The display unit 24a shows a rechargeable battery characteristic variable during operation. The rechargeable battery characteristic variable comprises a charge state of the rechargeable battery 22a for a handheld power tool. The rechargeable battery apparatus 10a for a handheld power tool also has an on and off switch 38a. The operator can switch a power output of the load interface 12a by means of the on and off switch 38a.

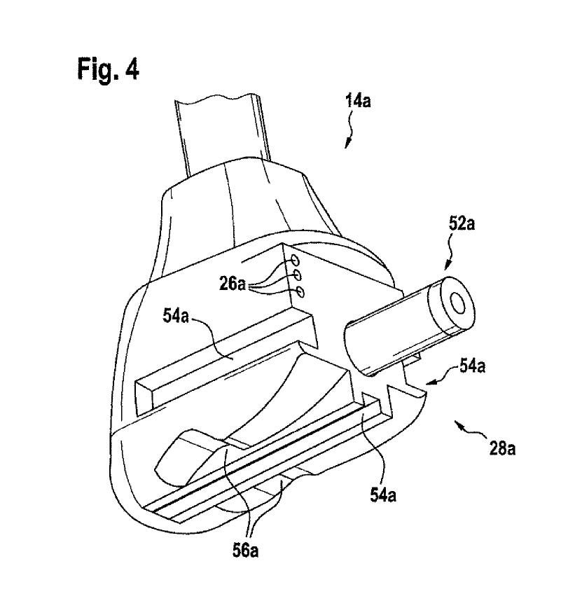

The load 14a has a coding means 26a, the supply interface 28a, a lamp unit 30a and a connecting apparatus 32a. As shown in FIGS. 3 and 4, the supply interface 28a complements the load interface 12a of the rechargeable battery apparatus 10a for a handheld power tool. The coding means 26a is arranged on the supply interface 28a such that it is arranged directly adjacent to the identification means 16a of the load interface 12a in a ready-to-operate state. As a result, the identification means 16a can evaluate the coding means 26a in a particularly reliable manner.

The supply interface 28a has grooves 54a. The linear guide 40a of the load interface 12a engages in the grooves 54a in the supply interface 28a in a ready-to-operate state. The supply interface 28a also has a latching region 56a. The latching region 56a latches with the latching apparatus 42a in a ready-to-operate state. Therefore, the supply interface 28a and the load interface 12a establish an interlocking connection in all directions in a ready-to-operate state.

In addition, the supply interface 28a comprises the mating contact 52a. Therefore, the supply interface 28a is especially intended to be connected to the load interface 12a of the rechargeable battery apparatus 10a for a handheld power tool.

The connecting apparatus 32a is in the form of a flexible tube, specifically a so-called swan neck. Therefore, in a ready-to-operate state, the connecting apparatus 32a arranges the lamp unit 30a and the supply interface 28a such that they can move relative to one another. An electrical line (not illustrated in any detail) is arranged in the connecting apparatus 32a. The electrical line operatively connects the supply interface 28a to an output interface 58a of the lamp unit 30a.

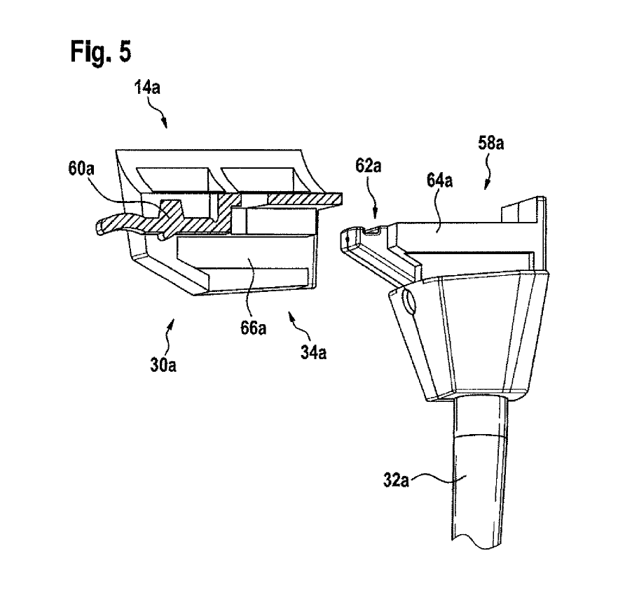

As shown in FIG. 5, the lamp unit 30a has an input interface 34a. In a ready-to-operate state, the input interface 34a makes contact with the output interface 8a of the connecting apparatus 32a in such a way that it can be detached without tools. The input interface 34a has a latching element 60a which can be operated by the operator. The output interface 58a of the connecting apparatus 32a has a latching cutout 62a which is latched to the latching element 60a in the ready-to-operate state. In addition, the output interface 58a of the connecting apparatus 32a has a linear guide 64a. The linear guide 64a engages in a grove 66a in the input interface 34a in a ready-to-operate state. Therefore, the output interface 58a of the connecting apparatus 32a and the input interface 34a are connected in an interlocking manner. Furthermore, the output interface 58a has a contact 68a. The contact 68a can move relative to the linear guide 64a.

As shown in FIG. 1 in particular, the lamp unit 30a, the connecting apparatus 32a and the rechargeable battery interface 20a and further units, which appear to be expedient to a person skilled in the art, of the rechargeable battery apparatus 10a for a handheld power tool form a rechargeable battery lamp 36a for a handheld power tool according to the disclosure. In this case, the rechargeable battery interface 20a is fixedly, detachably or advantageously permanently connected to the connecting apparatus 32a in at least one operating state. In a ready-to-operate state, the input interface 34a of the rechargeable battery lamp 36a for a handheld power tool makes contact with the connecting apparatus 32a in such a way that it can be detached without tools.

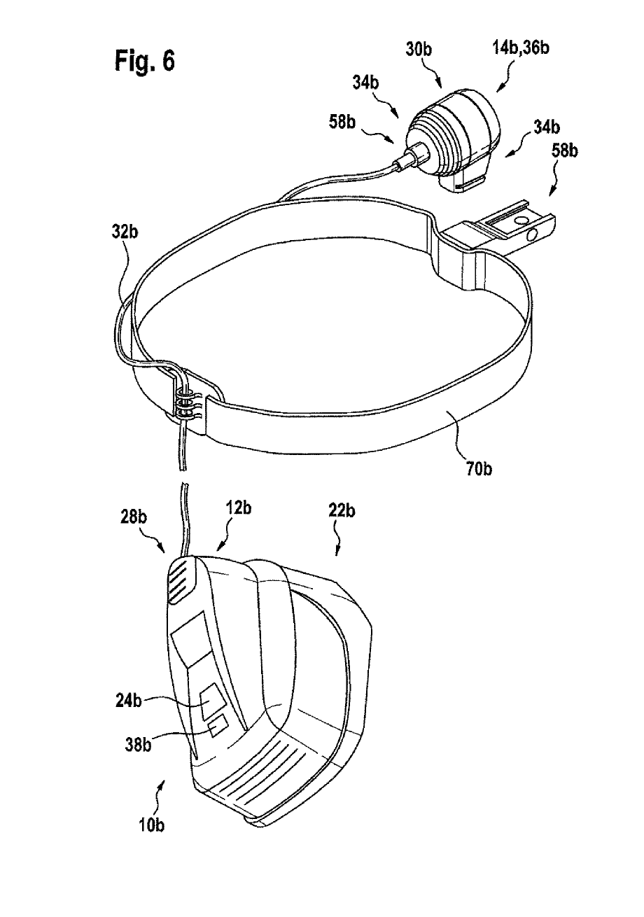

FIGS. 6 to 8 show two further exemplary embodiments of the disclosure. The following descriptions are limited substantially to the differences between the exemplary embodiments, it being possible to make reference to the description of the other exemplary embodiments, in particular of FIGS. 1 to 5, with regard to components, features and functions which remain the same. In order to distinguish between the exemplary embodiments, the letter a follows the references symbols of the exemplary embodiment in FIGS. 1 and 2. In the exemplary embodiments of FIGS. 6 to 8, the letter a is replaced by the letters b and c. Reference can also be made, in principle, to the drawings and/or the description of the other exemplary embodiments, in particular of FIGS. 1 to 5, with regard to components with the same designations, in particular in relation to components with the same reference symbols.

FIG. 6 shows a further exemplary embodiment of a load 14b according to the disclosure, a rechargeable battery apparatus 10b for a handheld power tool and a rechargeable battery 22b for a handheld power tool. The rechargeable battery apparatus 10b for a handheld power tool of this exemplary embodiment is structurally identical to the rechargeable battery apparatus 10a for a handheld power tool of the first exemplary embodiment. A lamp unit 30b of the load 14b is also structurally identical to the lamp unit 30a of the first exemplary embodiment.

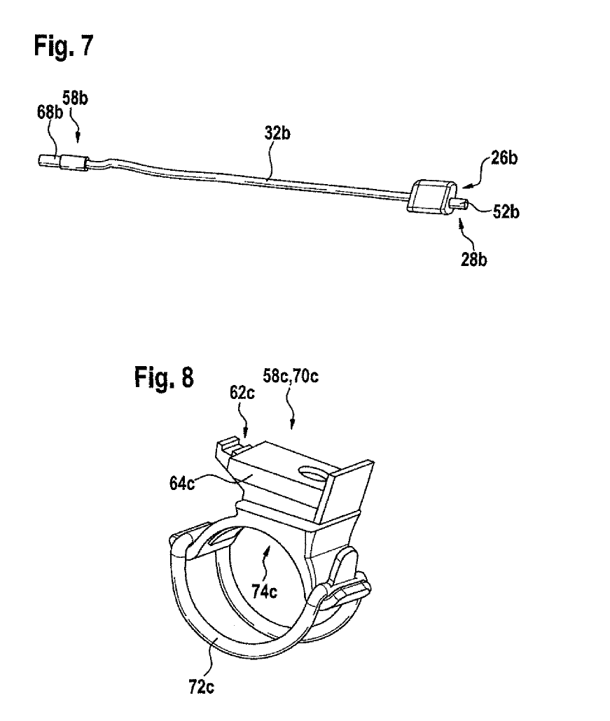

The load 14b has a connecting apparatus 32b. As shown in FIG. 7, the connecting apparatus 32b is in the form of a connecting cable. It passes on an electrical power to the lamp unit 30b, in particular to an input interface 34b of the lamp unit 30b, during operation. The connecting apparatus 32b comprises the coding means 26b and a supply interface 28b. The coding means 26b has a plurality of magnets. The supply interface 28b is connected to a load interface 12b of the rechargeable battery apparatus 10b for a handheld power tool according to the disclosure in a ready-to-operate state. In this case, the coding means 26b engages with an identification means 16b of the rechargeable battery apparatus 10b for a handheld power tool. As a result, the rechargeable battery apparatus 10b for a handheld power tool identifies the load 14b.

The connecting apparatus 32b also has a mounting apparatus 70b. The mounting apparatus 70b is in the form of a headband. It has a mechanical output interface 58b which is connected to the lamp unit 30b in a ready-to-operate state. To this end, the mounting apparatus 70b has a latching cutout 62b and a linear guide 64b.

FIG. 8 shows a part of a further exemplary embodiment of a load. It shows an alternative mounting apparatus 70c of a load (not illustrated in its entirety). The mounting apparatus 70c has a part of the output interface which mechanically connects a connecting apparatus of the load and the lamp unit. The mounting apparatus 70c has a mounting means 72c and a mounting area 74c. The mounting means 72c is in the form of an elastic band. In a mounted operating state, the mounting means 72c presses the mounting area 74c against an element on which the mounting apparatus 70c is mounted. The mounting area 74c is concave. Therefore, the mounting means 72c can advantageously be mounted on round objects.

What is claimed is:

1. A rechargeable battery apparatus for a handheld power tool, comprising at least one load interface configured to make contact with a load in a detachable manner, wherein the load interface has at least one identification mechanism configured to electronically identify the load.

2. The rechargeable battery apparatus for a handheld power tool according to claim 1, wherein the load interface has at least one electronics system which is configured to automatically influence a value of an output characteristic variable as a function of an identification process.

3. The rechargeable battery apparatus for a handheld power tool according to claim 1, wherein the identification mechanism has at least one magnetic field sensor.

4. The rechargeable battery apparatus for a handheld power tool according to claim 1, wherein the load interface is configured to establish a connection which can be mechanically loaded and is electrically conductive.

5. The rechargeable battery apparatus for a handheld power tool according to claim 1, further comprising at least one rechargeable battery interface which is configured to make contact with at least one rechargeable battery for a handheld power tool in a detachable manner.

6. The rechargeable battery apparatus for a handheld power tool according to claim 1, further comprising at least one display unit configured to display at least one rechargeable battery characteristic variable in at least one operating state.

7. A handheld power tool, comprising;
a load having a coding means and a supply interface; and
a rechargeable battery apparatus including at least one load interface configured to make contact with the load in a detachable manner, wherein the load interface has at least one identification mechanism configured to electronically identify the load.

8. The handheld power tool according to claim 7, wherein the load further has a lamp unit and a connecting apparatus which, in at least one operating state, arranges the lamp unit and the supply interface such that they can move relative to one another.

9. The handheld power tool according to claim 8, wherein the lamp unit has an input interface which is configured to make contact with the connecting apparatus in a detachable manner.

10. A rechargeable battery lamp for a handheld power tool, comprising:
a lamp unit;
a connecting apparatus; and
a rechargeable battery interface which is fixedly connected to the connecting apparatus in at least one operating state,
wherein the lamp unit has an input interface which is configured to make contact with the connecting apparatus in a detachable manner.
